(19) United States
(12) Patent Application Publication
(10) Pub. No.: US 2011/0086139 A1
(43) Pub. Date: Apr. 14, 2011

(54) FORTIFIED SWEETENER

(76) Inventor: Lincoln Wentworth Lawson, Marina del Rey, CA (US)

(21) Appl. No.: 12/578,490

(22) Filed: Oct. 13, 2009

(51) Int. Cl. A23L 1/22; A23L 1/30; A23L 1/303; A23L 1/304; A23L 1/236; A23L 1/09

(52) U.S. Cl. 426/73; 426/311

(57) ABSTRACT

A granular blend comprising a sweetener fortified with vitamins A, C, D, E, and K. The sweetener may comprise white or brown natural sugar, artificial sweetener, or a mixture of the two. The vitamins may optionally include vitamins B6 and B12, and iron. The granular blend may be provided in packaged form enclosed in an envelope.

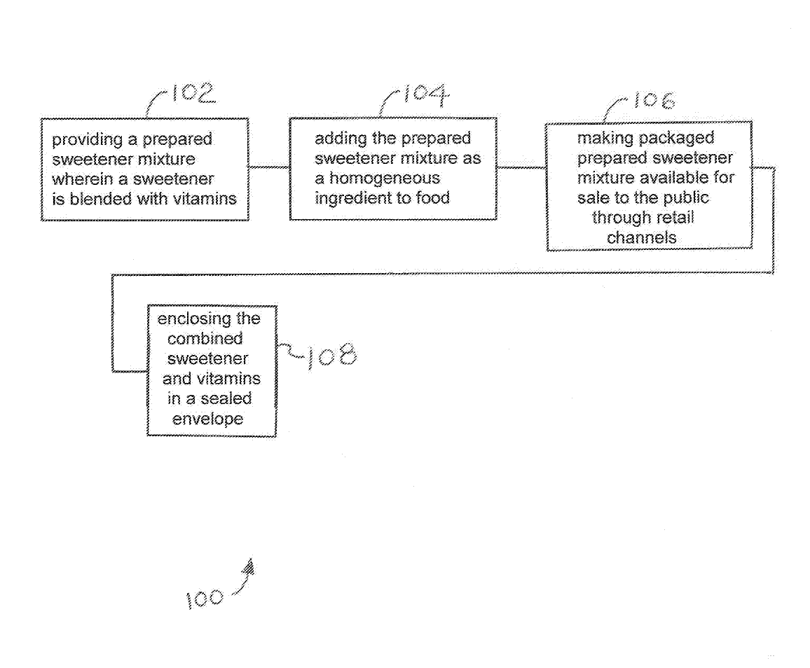

### FIELD OF THE INVENTION

The present invention relates to sweeteners and nutrition, and more particularly, to sweeteners having certain specific vitamins included therewith, such that the act of adding a sweetener to a food will also fortify that food with the specific vitamins.

### BACKGROUND OF THE INVENTION

Vitamins have long been provided for fortification or supplementing of foods in stand-alone form. That is, vitamins have been made available in tablet form for example, the tablets containing one or more vitamins. Such tablets are intended to be taken orally, preferably with a meal. Vitamin supplements such as vitamin tablets and the like require that the consumer maintain a supply of tablets, and ingest tablets at various times throughout the day.

Some prepared foods are fortified with additional vitamin content by the manufacturer which has prepared the foods. This requires that the consumer purchase specific prepared foods which may or may not be to the liking of those consumers.

The same limitations generally apply to manufacturers of prepared foods who wish to fortify foods with vitamins. The vitamins must be maintained in stock and added in predetermined dosages as an individual operation of an assembly line process.

Sweetening of foods is widely popular in the United States. Sugars such as cane sugar, beet sugar, and the like are added to foods both at the manufacturing level and also at the level of individual consumers.

It would be desirable to combine the functions of adding vitamins to food content when sweetening foods.

### SUMMARY OF THE INVENTION

The present invention provides a convenient way of adding vitamins to food content, which requires that those preparing the foods merely add a desired amount of a sweetener such as sugar to the foods. The sweetener is premixed with certain vitamins so that the act of sweetening the food also enriches the foods being sweetened with vitamins. No separate operation is required to infuse foods with vitamins when the sweetener is added.

The mixture of sweetener and vitamins may be utilized at the consumer level or at the manufacturing level. That is, a prepared mixture of vitamin fortified sweetener may be packaged for retail sales to consumers, or may be provided for use in commercial operations.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawing, which is a block diagram of steps of practicing the invention.

### DETAILED DESCRIPTION

The present invention contemplates providing a sweetener fortified with certain basic, essential vitamins in a form which is readily usable by consumers when sweetening foods. Of course, use by consumers, although presented as the essential contemplated use, is not the only way in which the novel fortified sweetener may be used. Rather, the novel fortified sweetener may be utilized commercially, industrially, or institutionally in mass packaging and preparation of foods which are to be sweetened. As used herein, the term “food” is intended to include both solids and liquids, including common beverages and the like.

The sweetener is preferably provided in granular, fluent form. Granular form may arise from any suitable method of processing the sweetener. Illustratively, one or more types of sugar may be initially dissolved in water, dewatered, and then granulated. Vitamins may be added to the liquid phase or to the granular phase of the sweetener.

The sweetener may be a natural sugar, such as beet sugar or cane sugar, and may be of any desired form, such as brown or white. Natural sugars may be raised or processed as organic, or according to non-organic commercial methods. The sweetener may comprise an artificial sweetener, such as saccharin, aspartame, sucralose, acesulfame K, or neotame. The sweetener may comprise a blend of natural sugars, a blend of artificial sweeteners, or any combination of these.

Vitamins may include at a minimum the vitamins A, C, D, E, and K. Optionally, vitamins B6 and B12, and iron may be added.

Regardless of the initial form, the final form will be granular. The final form may be packaged for storage in envelopes ranging from small portions, such as those corresponding in sweetness to a teaspoon of natural cane sugar, or in greater quantities.

It is the intent to provide a product which essentially behaves as and is immediately usable as conventional sugar, with the vitamin content not being generally discernible during preparation of foods, and not requiring any additional steps to add the vitamins to the foods being sweetened.

The invention may be regarded as a homogeneous blend of sweetener and fortifying vitamins, which may be added to foods being sweetened. Alternatively, and referring to the Drawing Figure, the invention may be thought of as a method 100 of preparing a food substance. The method 100 may comprise a step 102 of providing a prepared sweetener mixture wherein a sweetener is blended with vitamins such that the prepared sweetener mixture appears as a homogeneous mixture, and a step 104 of adding the prepared sweetener mixture as a homogeneous ingredient to food being prepared.

To facilitate practice of the invention by the general public, the method 100 may comprise a step 106 of making packaged prepared sweetener mixture available for sale to the general public through retail channels. The step 106 may comprise a further step 108 of enclosing the combined sweetener and vitamins in a sealed envelope enclosing the granular sweetener and the granular vitamin composition.

The enclosed granular sweetener and vitamin composition may be essentially the only contents of the sealed envelope, although in practice a certain incidental gaseous atmosphere will inevitably be present. It would be possible to provide an artificial gaseous atmosphere to preserve the qualities of vitamins with anti-oxidant properties. For example, the granular sweetener and vitamin composition may be provided with an ambient environment of nitrogen, carbon dioxide, argon, or other inert gas during packaging and handling.

The packaged product may be provided with certain incidental substances, such as carrier substances for binding to the vitamins, anti-caking agents to assure fluidity of the granular mass, barrier agents such as coatings disposed to isolate reactive vitamin particles from oxygen of surrounding ambient air, anti-spoilage agents, and wetting agents to assist in dispersing the sweetener and vitamins when blending into foods being sweetened. The invention may therefore be thought of as essentially comprising a granular sweetener, a granular composition comprising including vitamin A, vitamin C, vitamin D, vitamin E, and vitamin K, and a sealed envelope enclosing the granular sweetener and the granular composition comprising including vitamin A, vitamin C, vitamin D, vitamin E, and vitamin K.

Where no incidental substances are intentionally added, the invention may be thought of as a sweetener product fortified with vitamins and packaged for addition to foods by consumers as a homogeneous substance, which sweetener product may consist of a granular sweetener, a granular composition comprising including vitamin A, vitamin C, vitamin D, vitamin E, and vitamin K, and a sealed envelope enclosing the granular sweetener and the granular composition comprising including vitamin A, vitamin C, vitamin D, vitamin E, and vitamin K.

The invention may also be thought of as a product sweetened by a sweetener product fortified with vitamins. The product may comprise a base food substance, such as dough, batter mix, a beverage, or other food substance, into which has been mixed a granular sweetener having a sweetener component and a fortifying component, wherein the fortifying component comprises vitamin A, vitamin C, vitamin D, vitamin E, and vitamin K.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of preparing a food substance, comprising the steps of:
providing a prepared sweetener mixture wherein a sweetener is blended with vitamins such that the prepared sweetener mixture appears as a homogeneous mixture; and
adding the prepared sweetener mixture as a homogeneous ingredient to food being prepared.

2. The method of claim 1, wherein the step of providing a prepared sweetener mixture comprises the further step of providing a natural sugar.

3. The method of claim 2, wherein the step of providing a natural sugar comprises the further step of providing organically raised sugar.

4. The method of claim 2, wherein the step of providing a natural sugar comprises the further step of providing brown sugar

5. The method of claim 2, wherein the step of providing a natural sugar comprises the further step of providing cane sugar.

6. The method of claim 2, wherein the step of providing a natural sugar comprises the further step of providing beet sugar.

7. The method of claim 1, wherein the step of providing a prepared sweetener mixture comprises the further step of providing an artificial sweetener.

8. The method of claim 1, comprising the further step of packaging the prepared sweetener mixture for storage.

9. The method of claim 8, comprising the further step of making packaged prepared sweetener mixture available for sale to the general public through retail channels.

10. The method of claim 1, wherein the step of providing the prepared sweetener mixture comprises the further step of including vitamin A, vitamin C, vitamin D, vitamin E, and vitamin K in the prepared sweetener mixture.

11. The method of claim 11, wherein the step of including vitamin A, vitamin C, vitamin D, vitamin E, and vitamin K comprises the further step of including vitamin B6, vitamin B12, and iron.

12. A sweetener product fortified with vitamins and packaged for addition to foods by consumers as a homogeneous substance, comprising:
a granular sweetener;
a granular composition comprising including vitamin A, vitamin C, vitamin D, vitamin E, and vitamin K; and
a sealed envelope enclosing the granular sweetener and the granular composition comprising vitamin A, vitamin C, vitamin D, vitamin E, and vitamin K.

13. A product sweetened by a sweetener product fortified with vitamins, comprising:
a base food substance; and
a granular sweetener having a sweetener component and a fortifying component, wherein the fortifying component comprises vitamin A, vitamin C, vitamin D, vitamin E, and vitamin K.
